(19) United States
(12) Patent Application Publication
(10) Pub. No.: US 2017/0174875 A1
(43) Pub. Date: Jun. 22, 2017

(54) PAVING TILES MADE OF RUBBER MATERIALS AND ASSOCIATED METHODS

(71) Applicant: Roll-Tech Molding Products, LLC, Hickory, NC (US)

(72) Inventors: Patrice M. Bertrand, Hickory, NC (US); George J. Dallas, Hickory, NC (US)

(73) Assignee: Roll-Tech Molding Products, LLC, Hickory, NC (US)

(21) Appl. No.: 14/970,772

(22) Filed: Dec. 16, 2015

(51) Int. Cl. C08L 9/06; C08L 9/00; C08L 7/00; B32B 37/14; B32B 25/12; B32B 25/16; B32B 25/18; B32B 25/14; C08L 9/02; B32B 25/04

(52) U.S. Cl. CPC C08L 9/06; C08L 9/02; C08L 9/00; C08L 7/00; B32B 25/042; B32B 25/12; B32B 25/16; B32B 25/18; B32B 25/14; B32B 37/14; B32B 2250/248

(57) ABSTRACT

A paving tile is made of a first rubber material and a second rubber material that is dissimilar from the first rubber material. The first rubber material may be a recycled rubber material, such as crumb rubber granules from scrap vehicle tires. The second rubber material may be a nitrile rubber material, such as nitrile butadiene rubber (NBR). The crumb rubber material is disposed within a mold and leveled. A relatively thin layer of the NBR material is positioned onto the crumb rubber material and the crumb rubber material and the NBR material are chemically bonded without an adhesive using a compression molding process including at least one of a preselected pressure, a preselected temperature and a preselected period of time. The recycled rubber material may have a first color and the nitrile rubber material may have a second color that is different than the first color.

### FIELD OF THE INVENTION

This invention relates generally to paving tiles and methods for making, installing and using paving tiles. More particularly, the invention is a paving tile made of rubber materials, as well as associated methods of making, installing and using the paving tiles.

### BACKGROUND OF THE INVENTION

Paving tiles, commonly referred to as “pavers,” have long been used to form a relatively flat driveway, sidewalk, walkway, patio, floor or other support surface for people, animals, vehicles, machinery, small structures and the like. Historically, pavers have been constructed of a relatively hard, inelastic material, such as masonry, brick or concrete. Recently, innovative manufacturers have begun to construct pavers from softer and more elastic materials, such as plastic, rubber and composites, that are significantly more energy absorbing and, in many instances, more durable and resistant to exposure to caustic chemicals and the environment.

One example of a paver made of a rubber material is available from China Exact Plastic Co., Ltd. located in the city of Qingdao on the Shandong Peninsula of China. The interlocking dog-bone shaped rubber paver is available in a variety of colors and thicknesses ranging from about 0.4 inches (1.0 cm) to about 1.7 inches (4.3 cm). Another interlocking dog-bone shaped rubber paver is distributed via an Internet website by Diamond Safety Concepts of Olivenhain, Calif., USA, under the brand name FLEXGARD®. The FLEXGARD® rubber paver is available in different colors with either a 1 inch (2.54 cm) or a 1.75 inch (4.4 cm) thickness. The paver is about 7.8 inches (19.8 cm) in length and about 6.2 inches (15.7 cm) in width at each end with a width of about 4.4 inches (11.2 cm) in the central area of the paver. The 1 inch (2.54 cm) thick paver has a weight of about 1.3 lbs (0.59 kg), and the 1.75 inch (4.4 cm) thick paver has a weight of about 2.3 lbs (1.04 kg). As a result, 3.5 pavers are required to cover an area of about 1 square foot (0.09 square meters).

A larger dog-bone shaped paving tile made of recycled rubber material is available in various colors from New Century Northwest LLC of Eugene, Oreg., USA. Each interlocking paving tile is formed into a 2 square foot (0.18 square meters) area with a 1 inch (2.54 cm) thickness so that a single large paving tile has the appearance of 18 individual dog-bone shaped pavers. The larger footprint of the paving tile provides improved stability to overcome the problem of individual pavers shifting following installation, and also reduces maintenance after installation by limiting the number of cracks between adjacent pavers in which weeds may grow and debris may collect.

In addition to being an affordable, environmentally friendly alternative to paving stones, bricks, concrete, asphalt and other conventional support surfaces, rubber paving tiles also reduce installation costs since the pavers are a “floating surface” that is held in place only by an outside perimeter. Because rubber paving tiles are softer than stone, brick, concrete or asphalt, the finished surface creates a safer environment for sidewalks, walkways, patios, pool decks, floors and the like. Furthermore, their durable finished surface is long-lasting and resistant to cracking, staining and pitting, for example from exposure to caustic chemicals. In addition, the paving tile can include additives that make the surface slip resistant and/or resistant to environmental effects, such as swelling, rot, biological attack and erosion due to extreme temperatures and/or adverse weather conditions.

Another interlocking paver for constructing sidewalks, walkways, patios, outdoor decks and floors is made from ethylene propylene diene monomer (EPDM) rubber, commonly referred to as M-class rubber due to its classification in the American Society for Testing and Materials (ASTM) Standard D-1418. EPDM rubber is a type of synthetic rubber having a saturated chain of the polymethylene type that is a terpolymer of ethylene, propylene and a diene component. The ethylene content is typically between about 45% and about 75%. A higher ethylene content results in a higher loading possibility of the polymer, as well as better mixing and extrusion. The diene content typically ranges from about 2.5% up to about 12% by weight of the composition and forms crosslinks when the composition is cured with sulphur and resin. When cured with peroxide, the diene functions as a co-agent and provides resistance to tackiness, creep and flow during use.

The primary advantages of EPDM rubber are its superior resistance to elevated temperatures, ozone and adverse weather, along with its above average resistance to ketones, ordinary diluted acids and alkalines. EPDM rubber has a Shore A hardness between about 40 durometer and about 90 durometer, a relatively low linear coefficient of thermal expansion, and a service temperature range from about negative 50° C. up to 150° C. EPDM rubber is commonly used as a roofing membrane material since it does not pollute rainwater run-off. EPDM granules are also mixed with polyurethane binders and sprayed onto pool decks and playgrounds to create a relatively soft, slip-resistant and generally porous safety surface.

Despite the advantages over stone, masonry, concrete and asphalt provided by paving tiles made of rubber material, certain deficiencies remain. In particular, existing rubber paving tiles are formed of a composition of a single rubber material having a generally uniform density throughout the thickness of the paver. Secondly, existing pavers made of a rubber material are formed with a relatively narrow range of physical and mechanical properties. Thirdly, existing rubber paving tiles have less than desirable surface friction, hardness and durability. Thus, there exists a need for an improved paving tile made of a rubber material. In particular, there exists a need for a paving tile made of a rubber material having a variable density through the thickness of the paver. There exists a further need for rubber pavers with improved surface friction, hardness and durability.

### SUMMARY OF THE INVENTION

The present invention provides a paving tile made of rubber materials and associated methods of making and using the paving tiles. In one aspect, the invention is embodied by a paving tile made of a first rubber material and a second rubber material that is dissimilar from the first rubber material. The first rubber material and the second rubber material may be blended together and fused. Alternatively, the first rubber material and the second rubber material may be bonded together with an adhesive. Alternatively, the first rubber material and the second rubber material may be bonded together without an adhesive, for example chemically bonded.

In another aspect, the invention is embodied by a paving tile made of a first rubber material and a second rubber material that is dissimilar from the first rubber material, wherein at least one of the first rubber material and the second rubber material is a recycled rubber material. In one embodiment, the recycled rubber material includes at least one of a styrene-butadiene rubber (SBR), a butyl rubber (BR) and a natural rubber (NR) that has been previously cured. In another embodiment, the first rubber material is a recycled rubber material and the second rubber material is a rubber material that has been vulcanized. The vulcanized rubber material is selected from the group consisting of a natural rubber and a synthetic rubber that has been vulcanized by the addition of sulfur. The synthetic rubber is selected from the group consisting of ethylene propylene diene monomer (EPDM) rubber, SBR, BR and nitrile rubber. The nitrile rubber is selected from the group consisting of Buna-N, Perbunan, acrylonitrile butadiene rubber and nitrile butadiene rubber (NBR). In an advantageous embodiment, the recycled rubber material consists of crumb rubber granules recycled from scrap vehicle tires and the crumb rubber granules and the vulcanized rubber material are bonded together by a catalyst including sulfur and an accelerator.

In a particularly advantageous embodiment of the paving tile, the recycled rubber material is a crumb rubber material and the vulcanized rubber material is a nitrile rubber material. A relatively thin layer of the nitrile rubber material is bonded onto the crumb rubber material without an adhesive, for example chemically bonded, to form a unitary paving tile. In one embodiment, the nitrile rubber material is bonded onto the crumb rubber material within a mold using a compression molding process. As a result of the compression molding process, the peel strength of the bond between the crumb rubber material and the nitrile rubber material is at least as great as about 13 foot-pounds per inch (13 (ft-lbs)/in).

In another aspect, the invention is embodied by a method of making a paving tile from rubber materials. The method includes providing a first rubber material and providing a second rubber material that is dissimilar from the first rubber material. The method further includes bonding the first rubber material and the second rubber material together using a catalyst including sulfur and an accelerator. In one embodiment, the step of bonding the first rubber material and the second rubber material together includes bonding (e.g., chemically) without an adhesive. The method further includes disposing the first rubber material within a mold, positioning a comparatively thin layer of the second rubber material onto an upper surface of the first rubber material, and applying at least one of a preselected temperature, a preselected pressure and a preselected time to the first rubber material and the second rubber material within the mold. In another embodiment, the method further includes leveling the first rubber material after disposing the first rubber material within the mold and before positioning the layer of the second rubber material onto the first rubber material.

In particularly advantageous embodiments, the first rubber material is a recycled rubber material and the second rubber material is a nitrile rubber material. The recycled rubber material includes at least one of a styrene-butadiene rubber (SBR), a butyl rubber (BR) and a natural rubber (NR) that has been previously cured. The nitrile rubber material is selected from the group consisting of Buna-N, Perbunan, acrylonitrile butadiene rubber and nitrile butadiene rubber (NBR). Preferably, the recycled rubber material is crumb rubber granules and the nitrile rubber material is nitrile butadiene rubber (NBR).

In yet another aspect, the invention is embodied by a paving tile made of a recycled rubber material and a nitrile rubber material by disposing the recycled rubber material within a mold, leveling the recycled rubber material, positioning a relatively thin layer of the nitrile rubber material onto the recycled rubber material, and performing a molding process comprising at least one of a preselected temperature, a preselected pressure and a preselected time.

### BRIEF DESCRIPTION OF THE DRAWING FIGURES

FIG. 1 is a top perspective view of an exemplary embodiment of a paving tile made of rubber material and constructed in accordance with the present invention.

FIG. 2 is a bottom perspective view of the paving tile of FIG. 1.

FIG. 3 is a top plan view of the paving tile of FIG. 1.

FIG. 4A is a cross-sectional elevation view of the paving tile of FIG. 1 taken along the line 4A-4A in FIG. 3.

FIG. 4B is an end elevation view of the paving tile of FIG. 1, the opposite end of the paving tile being essentially identical.

FIG. 5 is a top plan view of another exemplary embodiment of a paving tile made of rubber material and constructed in accordance with the present invention.

FIG. 6 is a top plan view of yet another exemplary embodiment of a paving tile made of rubber material and constructed in accordance with the present invention.

FIG. 7A is a top perspective view of a plurality of the paving tiles of FIG. 1 interlocked together to form a support surface in accordance with an exemplary embodiment of the present invention.

FIG. 7B is a bottom perspective view of the plurality of paving tiles of FIG. 7A.

FIGS. 8-11 are a series of environmental views illustrating a method of installing a support surface formed of paving tiles made of rubber material in accordance with an exemplary embodiment of the present invention.

FIG. 12 is a flowchart depicting a method of making a paving tile from rubber materials in accordance with an exemplary embodiment of the present invention.

### DETAILED DESCRIPTION OF EXEMPLARY EMBODIMENTS OF THE INVENTION

The accompanying drawing figures, in which like reference numerals denote like elements throughout the various views, illustrate exemplary embodiments of paving tiles made of rubber materials and associated methods of making, installing and using the paving tiles in accordance with the present invention. In the exemplary embodiments shown and described herein, a paving tile made of rubber materials according to the invention is indicated generally by the reference character 20. The paving tile 20 is also referred to herein as a “paver.” In the various embodiments, the paver 20 is preferably made at least partially of a recycled rubber material, for example from scrap vehicle tires, commonly referred to as “crumb rubber.” In certain of the embodiments, the paver is further made of ethylene propylene diene monomer (EPDM) rubber, commonly referred to as M-class rubber. In certain other embodiments, the paver is further made of nitrile rubber, a synthetic rubber also commonly known as Buna-N, Perbunan, acrylonitrile butadiene rubber and nitrile butadiene rubber (NBR).

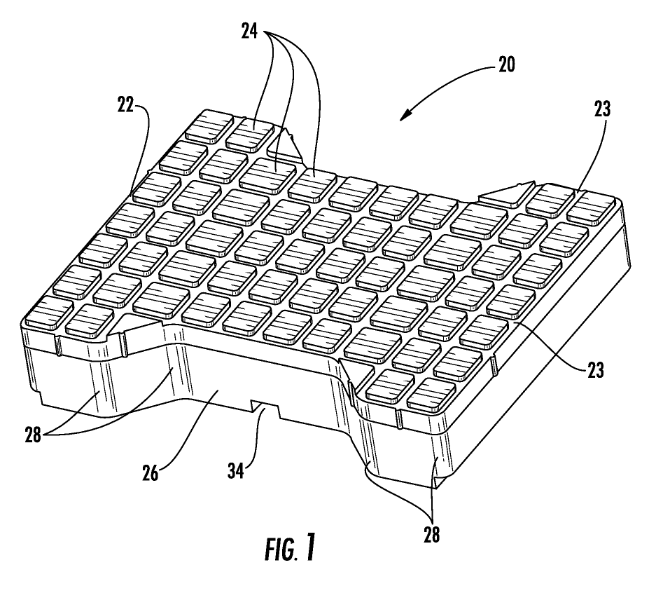

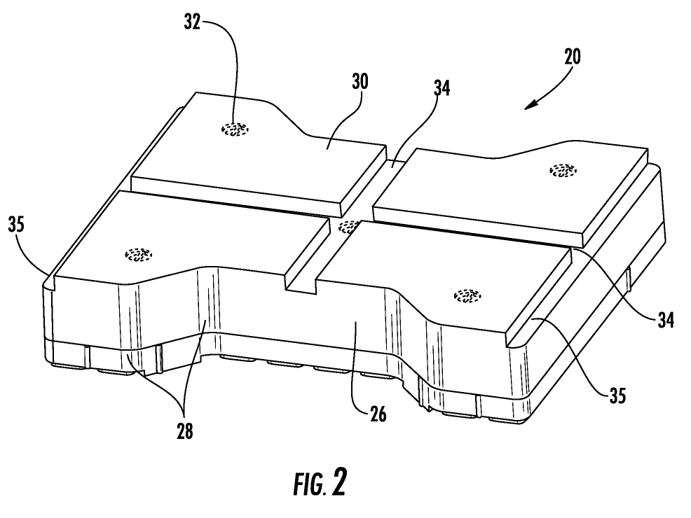

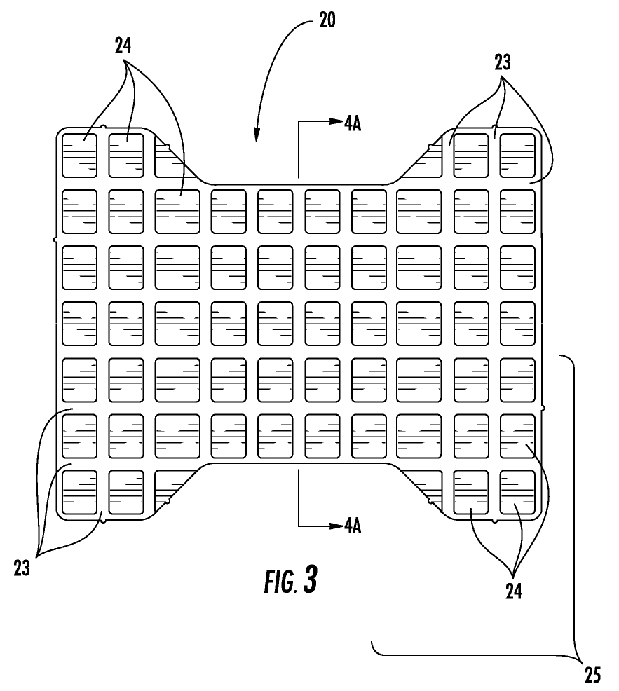

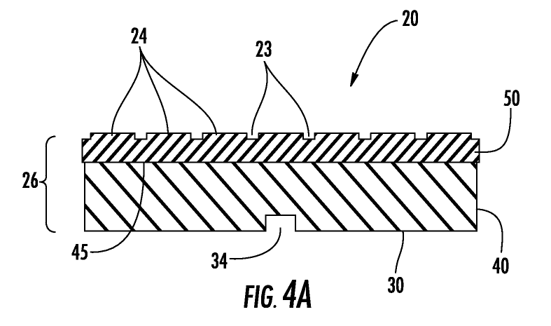

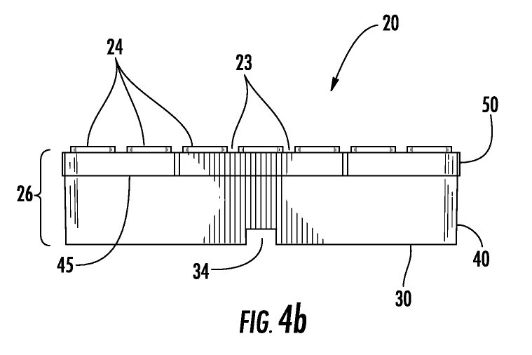

FIG. 1 is a top perspective view of a paving tile 20 constructed in accordance with an exemplary embodiment of the present invention. FIG. 2 is a bottom perspective view of the paving tile 20. FIG. 3 is a top plan view of the paving tile 20. FIG. 4A is a cross-sectional elevation view of the paving tile 20 taken through a center portion of the paving tile indicated by line 4A-4A in FIG. 3. FIG. 4B is an end elevation view of one end of the paving tile 20. The opposite end of the paving tile is essentially identical, and therefore, not shown herein for purposes of brevity. As best shown in FIG. 1 and FIG. 3, the paving tile 20 has a generally planar top surface 22 defining a predetermined pattern thereon. The predetermined pattern may be provided for aesthetic or utilitarian purposes, such as improved surface friction, or both. By way of example and not limitation, the predetermined pattern formed on the top surface 22 may comprise a plurality of upwardly depending features 24, such as projections, protrusions or the like, separated by corresponding undercuts 23, such as depressions, recesses or the like. The predetermined pattern may be formed on the top surface 22 in a secondary operation after the paving tile 20 is made, for example by removing the rubber material from the undercuts 23 by machining with a conventional tool. Preferably, however, the undercuts 23 and features 24 are formed by a mold in the same molding process that is used to make the entire paving tile 20.

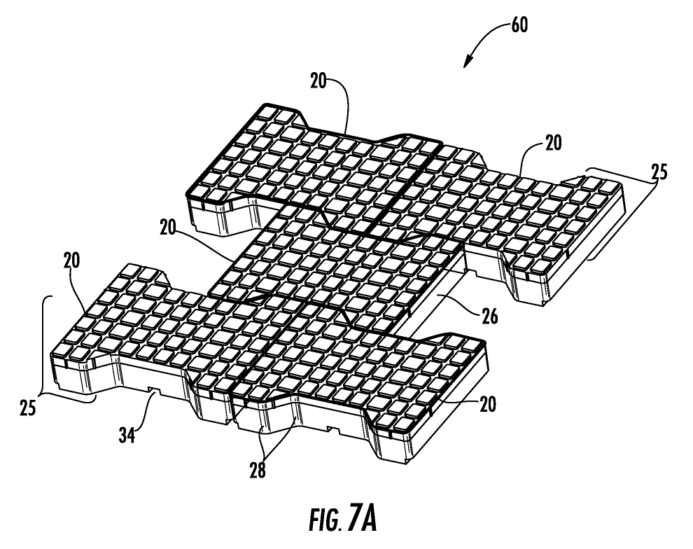

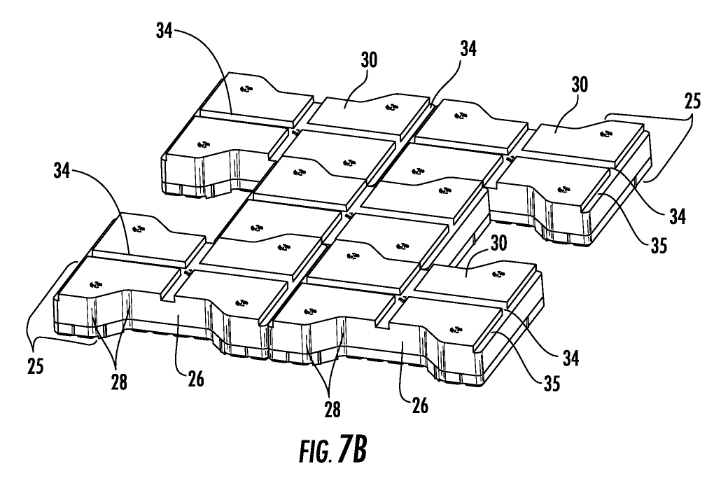

In addition to the top surface 22, the paving tile 20 has a continuous side surface 26 that extends around the entire periphery 25 (FIG. 3) of the paver. The shape of the periphery 25 defined by the side surface 26 of the paver 20 may be irregular, if desired, but preferably is regular for ease of installation, as will be described in greater detail hereinafter. If irregular in shape, the periphery 25 may have a random shape or may have a plurality of predetermined shapes so as to form an overall pattern or impression when installed. If regular in shape, the periphery 25 may be any desired shape, for example rectangular, square, circular, oval, elliptical, polygonal, etc. In advantageous embodiments, however, the periphery 25 of the paver 20 has an interlocking shape, such as hexagonal, diamond, cross, keystone, double-keystone, dog-bone, etc. As shown and described in the exemplary embodiments provided herein, the periphery 25 of each of the paving tiles 20 is a regular, interlocking dog-bone shape with the manner of interlocking being illustrated by the plurality of the pavers depicted in FIG. 7A and FIG. 7B.

If desired, the continuous side surface 26 may be generally smooth and consistent around the entire periphery 25. Preferably, however, the side surface 26 defining periphery 25 has one or more geometry features, such as undercuts, recesses, openings, indentations, protrusions, projections and the like, that are provided for a utilitarian purpose or function. The geometry features on side surface 26 may, if desired, be provided for aesthetic purposes as well. Typically, however, the side surface 26 of the paving tile 20 is obscured from view when the pavers are installed for use. In advantageous embodiments, one such geometry feature comprises a plurality of vertically oriented ribs 28 that extend outwardly from the side surface 26 in a direction generally parallel to a plane defined by the top surface 22. Ribs 28 are provided on side surface 26 to ensure a consistent spacing between adjacent paving tiles 20 in an installation of interlocking pavers, such as depicted in FIG. 7A and FIG. 7B. In the exemplary embodiments of the pavers 20 shown and described herein, side surface 26 further has a series of openings, cutouts or the like, that will be described in greater detail hereinafter with respect to a bottom surface 30 of the paver 20. In addition, side surface 26 may be smooth, rough or textured as desired to provide an aesthetic and/or utilitarian function. As previously mentioned, ribs 28 and any other feature on side surface 26, such as a roughened or textured surface, may be formed in a secondary operation after the paving tile 20 is made, for example by machining with a conventional tool. Preferably, however, ribs 28 and any other feature on side surface 26 are formed by a mold in the same molding process that is used to make the entire paving tile 20.

As best shown in FIG. 2, the paving tile 20 further has a bottom surface 30 that is substantially parallel to top surface 22 and that is substantially perpendicular to side surface 26. Bottom surface 30 may be generally planar, but preferably includes a plurality of geometry features, such as undercuts, indentations, openings, recesses or the like that are provided for a utilitarian purpose or function. The geometry features on bottom surface 30 may, if desired, be provided for aesthetic purposes as well. Typically, however, the bottom surface 30 of the paving tile 20 is obscured from view when the pavers are installed for use. In advantageous embodiments shown and described herein, one or more generally cylindrical openings 32 may be formed in the bottom surface 30 for the purpose of receiving pegs, posts, projections, protrusion or the like of a complementary base structure, such as a foundation mat, that serves to prevent or reduce shifting of the pavers 20 in an interlocking, free-floating installation. Alternatively, or in addition, one or more channels 34 may be formed in the bottom surface 30 for the purpose of facilitating water drainage beneath a plurality of the pavers 20 in an interlocking installation, such as depicted in FIG. 7A and FIG. 7B. As best shown in FIG. 2, the bottom surface 30 of paving tile 20 may have full channels 34 that extend along the length and across the width of the paver 20, as well as half channels 35 that extend across the width of the paver adjacent each end. As such, the full channels 34 and half channels 35 of adjoining interlocking pavers 20 interconnect to form a continuous water drainage system.

In a particularly advantageous embodiment, the features 24 on the top surface 22 of the paving tile 20 comprise a plurality of projections, protrusions or the like that extend upwardly and depend outwardly from the top surface. As previously mentioned, features 24 define a predetermined pattern for aesthetic purposes, utilitarian purposes, or both. In the exemplary embodiments shown and described herein, the predetermined pattern of features 24 is aligned generally lengthwise and generally widthwise such that the predetermined pattern appears substantially continuous and/or repeating in an installation of a plurality of adjoining, interlocking pavers 20, such as depicted in FIG. 7A. If desired, however, the predetermined pattern of features 24 may be arranged in a substantially random manner so as to appear natural, for example when the features are intended to simulate pebbles, small rocks or the like. Alternatively, the top surface 22 may be devoid of features 24, such that the top surface is essentially flat and planar, except for any texture (e.g., roughness) of the rubber material that forms the top surface.

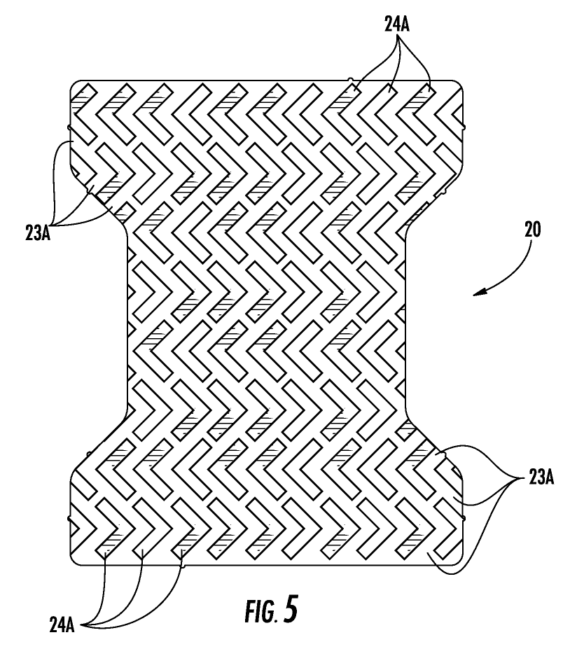

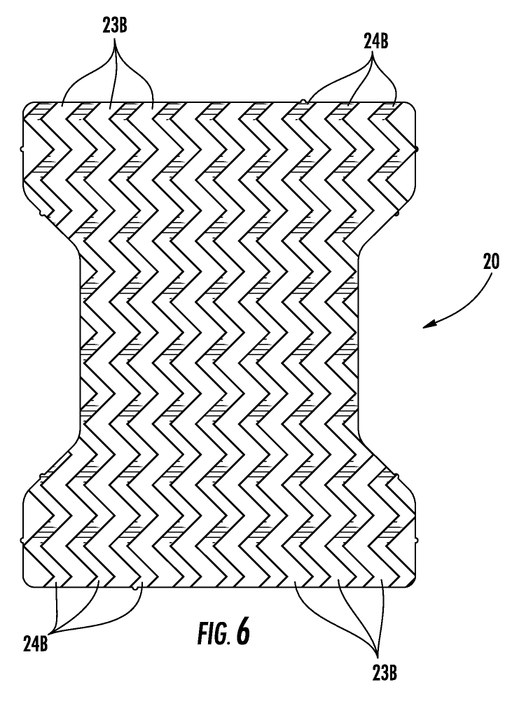

As best seen in FIG. 3, the top surface 22 defines a predetermined pattern of projections 24 separated by channels 23 that extend around the periphery of each the projections. The projections 24 may have any desired regular or irregular shape, and further may be consistent or inconsistent in size (i.e., in plan form area and/or height, thickness or depth). In advantageous embodiments, the projections 24 have a regular geometric shape, for example generally square, rectangular, circular, oval, elliptical, etc. In the embodiment of the paver 20 shown in FIG. 1 and FIG. 3, the projections 24 are generally square and/or rectangular shaped with rounded corners. Alternatively, in the exemplary embodiment of the paver 20 shown in FIG. 5, the projections 24A define a regular, repeating, generally chevron shaped pattern separated by serpentine channels 23A. In yet another exemplary embodiment of a paver 20 constructed in accordance with the present invention and shown in FIG. 6, the projections 24B defined by the top surface 22 of the paving tile have a somewhat irregular, repeating shape that emulates the tread pattern of a vehicle tire. Similarly, the projections 24B are separated by serpentine channels 23B. As will be readily appreciated and acknowledged by those having skill in the relevant art, innumerable different predetermined patterns of features 24 can be envisioned having an aesthetic and/or utilitarian purpose that is advantageous to a paving tile 20 constructed in accordance with the present invention.

Returning again to the exemplary embodiment of FIG. 1, FIG. 4A and FIG. 4B illustrate that the paving tile 20 may be made of dissimilar materials. More particularly, paving tile 20 may comprise a first rubber material 40 and a second rubber material 50. In advantageous embodiments, the first rubber material 40 has different material properties than the second rubber material 50. For example, the first rubber material 40 may be a comparatively softer, relatively elastic material for providing increased energy absorption, while the second rubber material 50 may be a comparatively harder, relatively inelastic material for providing increased toughness and durability. Furthermore, the color of the first rubber material 40 may be different than the color of the second rubber material 50.

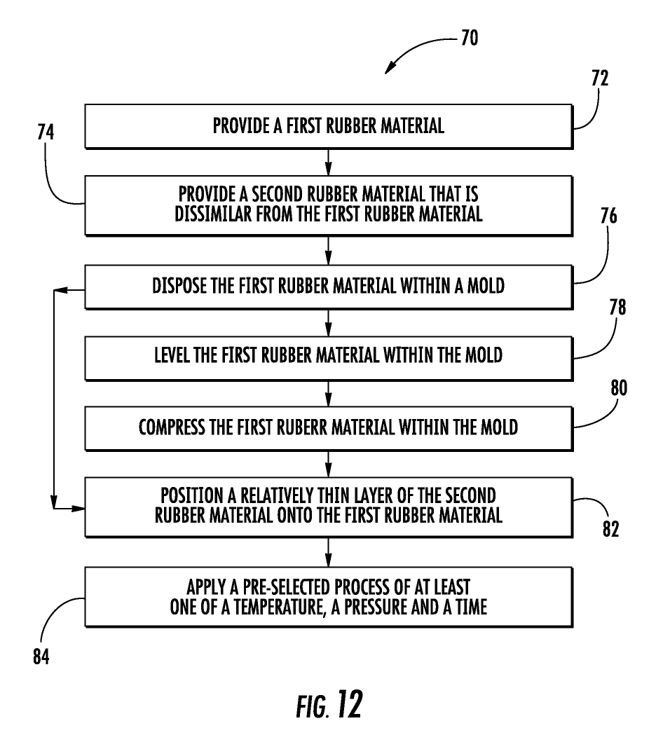

As will be readily understood and appreciated by those skilled in the art, the first rubber material 40 and the second rubber material 50 may be dissimilar materials having different mechanical and material properties that are selected to provide desired attributes and performance characteristics of the paving tile 20. By way of example and not limitation, first rubber material 40 and second rubber material 50 may be dissimilar rubber materials selected to provide desired strength, stiffness, hardness, durability, surface friction and/or chemical and/or environmental resistance properties, attributes or characteristics. In addition, at least the first rubber material 40 may be selected to optimize cost of materials and/or processing of the paver 20. In advantageous embodiments, the first rubber material 40 may be a recycled rubber material commercially and commonly referred to as “crumb rubber” procured from scrap vehicle tires. Paving tiles 20 made from a first rubber material 40 and a second rubber material 50 in accordance with exemplary embodiments of the present invention will be described in greater detail hereinafter with reference to FIG. 12.

As previously mentioned, FIG. 7A is a top perspective view and FIG. 7B is a bottom perspective view showing a plurality of the paving tiles 20 interlocked together to form a support surface 60 in accordance with an exemplary embodiment of the present invention. By way of example and not limitation, the plurality of paving tiles 20 are shown and described herein to be dog-bone shaped, interlocking pavers. However, it should be understood that the present invention is intended to encompass interlocking pavers 20 having any suitable shape, such as hexagonal, diamond, cross, keystone, double-keystone, etc. As used herein, the term “interlocking” is intended to mean merely that adjacent paving tiles 20 nest together to form a substantially planar support surface 60 without significant cracks, voids or space between the adjacent pavers. As such, rectangular paving tiles 20 having the shape of conventional masonry bricks arranged in a parquet manner, or arranged in adjacent rows, whether staggered or not, are considered to be “interlocking” within the meaning of that term intended by the present invention. In FIG. 7A, the periphery 25 of certain of the dog-bone shaped paving tiles 20 is depicted by a thicker solid line to emphasize the manner in which the pavers interlock with one another.

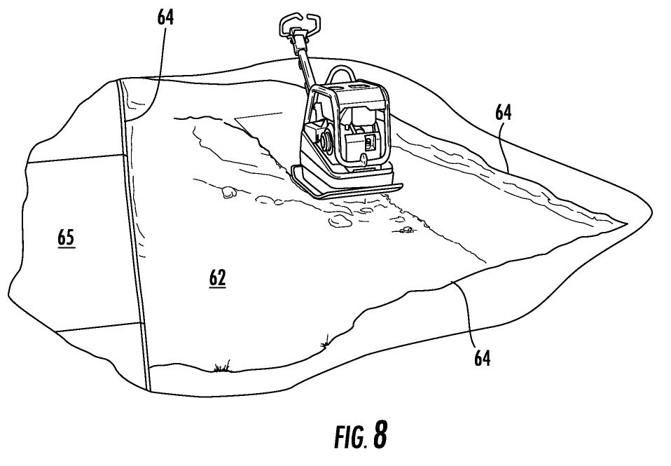

FIGS. 8-11 are environmental perspective views illustrating a method of installing a support surface 60 formed from paving tiles 20 made of rubber material in accordance with an exemplary embodiment of the present invention. In the exemplary embodiment shown and described herein, a plurality of the paving tiles 20 are used to form a turnout, or turn-around area, for golf carts on a golf course. The paving tiles 20 are especially well suited for use on turnouts, cart paths and the like on a golf course because the pavers are more energy absorbing than conventional cart path construction materials, such as concrete, asphalt or brick. The paving tiles 20 also require less maintenance after installation than crushed stone, wood chip, grass or dirt cart paths. In addition, the paving tiles 20 may be provided with an anti-slip pattern or texture on top surfaces 22 for increased safety. Furthermore, compared to other surfaces, the paving tiles 20 are more resistant to caustic chemicals and more resistant to erosion, cracking, breaking and separating due to effects of the environment, such as rain and temperature fluctuations and extremes. Paving tiles 20 are typically manufactured in a black color consistent with recycled rubber material, such as crumb rubber from scrap vehicle tires. However, the rubber material may be colored as desired with additives prior to manufacture (i.e., molding) for aesthetic purposes and/or protection from exposure to chemicals and ultraviolet (UV) radiation. Alternatively, only the top surface 22 of the paving tiles 20 may be colored after molding in a post-manufacturing coating, painting, wiping, staining or dipping process.

Regardless, the area 62 for installing the paving tiles 20 is prepared as illustrated by FIG. 8 using an excavating machine, such as a small bulldozer, Bobcat® tractor, or the like. Alternatively, area 62 may be prepared using hand tools, such as a shovel, rack, pickax, etc. The boundaries 64 of the installation area 62 are defined by adding about one foot of buffer to the desired footprint of the paving tiles 20, except along an existing support surface, such as a cart path 65, intended to be adjacent an edge of the paving tiles. The installation area 62 is excavated to a depth of about six inches below the level of the adjacent ground, or alternatively, below the level desired for the finished support surface 60 of pavers 20. With conventional-sized dog-bone shaped paving tiles 20, the number of pavers needed for the installation can be estimated using 3.4 pavers per square foot of the desired footprint of the finished support surface 60.

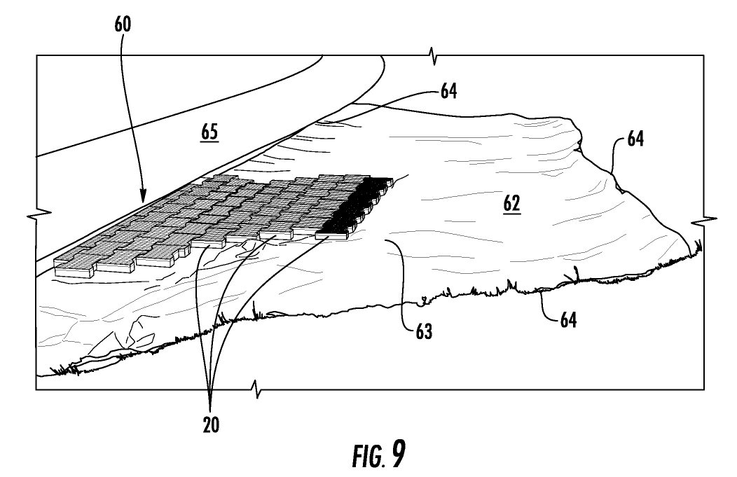

Next, the bare ground within the installation area 62 is compacted either manually or using a compacting machine, as desired. The installation area 62 is then filled with up to two inches of Aggregate Base Coarse (ABC), also commonly known as “Crush N Run” or “crush run,” comprising stones up to one inch in diameter and stone particles down to sand grain size referred to as fines. The installation area 62 filled with the ABC material is then compacted again. Preferably, the filling and compacting steps are repeated with another layer of up to about two inches of ABC material. By way of example and not limitation, an installation area 62 of about two thousand (2000) square feet may require up to four tons (8000 lbs) of ABC material. If desired, the installation area 62 may then be finished with leveling sand. The installation area 62 is next optionally covered with a permeable barrier 63, such as a polypropylene black woven stabilization fabric, commonly known as geotextile. As shown in FIG. 9, the paving tiles 20 are then placed within the installation area 62 in any desired manner and pattern, but preferably, in a predetermined pattern of interlocking pavers, for example as depicted in FIG. 7A and FIG. 7B.

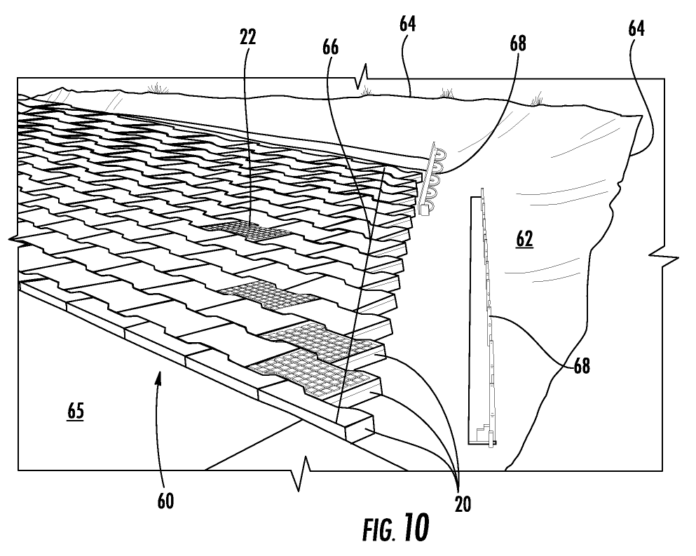

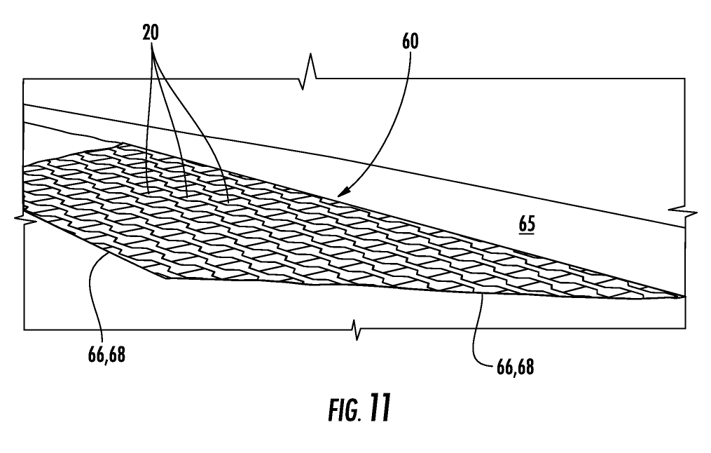

As shown in FIG. 10, a sufficient number of the paving tiles 20 are positioned within the installation area 62 to provide the desired footprint of the support surface 60. If desired, the ends of the pavers along a periphery of the support surface 60 are marked with a trim line 66 for cutting the pavers to a smooth edge. The ends of the pavers 20 are then cut, for example using a masonry circular saw or the like, along the trim line 66. Again if desired, the smooth edges of the paving tiles 20 cut along the trim line 66 may be secured with an edger 68 that is staked into the ground along the periphery of the support surface 60. As illustrated by FIG. 11, the installation area 62 between the boundaries 64 and the trim line(s) 66 and/or the edger(s) 68 is then backfilled with dirt from the excavation, compacted and and smoothed to the desired level, typically to the level of the support surface 60 formed from the pavers 20. If desired, the support surface 60 of paving tiles 20 may be topped with natural sand or polymeric sand, which may be colored, for example green, for aesthetic purposes. The support surface 60 formed from pavers 20 made of a rubber material is shown herein by way of example as a trapezoidal shaped turnout area adjacent to a conventional cart path on a golf course. However, the support surface 60 may be any desired shape and may be provided for any suitable purpose, for example, as a platform of a loading dock at a manufacturing facility or as a floor of an animal barn or the like, such as a horse stable.

As previously mentioned, in advantageous embodiments the paving tile 20 is made of dissimilar rubber materials. In particular, the paving tile 20 may be made of a first rubber material 40 and a second rubber material 50 that is dissimilar to the first rubber material. As depicted in FIG. 4A, the first rubber material 40 comprises bottom surface 30 and a portion of the side surface 26 around the entire periphery 25. Conversely, the second rubber material 50 comprises the top surface 22 and a portion of the side surface 26 around the entire periphery 25. As a result, the first rubber material 40 and the second rubber material 50 define a plane of intersection 45 on which the first and second rubber materials are joined together. Preferably, the first rubber material 40 extends upwardly from the bottom surface 30 over a majority of the side surface 26, such that the thickness of the first rubber material is substantially greater than the thickness of the second rubber material 50. In advantageous embodiments, the thickness of the first rubber material 40 is between about sixty percent (60%) and about ninety-eight percent (98%) of the overall thickness of the finished paver 20. In particularly advantageous embodiments, the thickness of the first rubber material 40 is between about seventy-five percent (75%) and about ninety-five percent (95%) of the overall thickness of the finished paver 20. In still other embodiments, the thickness of the second rubber material 50 is no more than about ten percent (10%) of the overall thickness of the paver 20.

In one advantageous embodiment, the paving tile 20 is made of a first rubber material 40 comprising recycled rubber material, such as crumb rubber from scrap vehicle tires. Crumb rubber is also commonly referred to as “junk rubber,” or alternatively, as “dirty rubber” or “black rubber,” due to the dark grey or black color of the recycled rubber material. Typically, crumb rubber is a granulated blend of styrene-butadiene rubber (SBR), butyl rubber (BR) and natural rubber (NR) that has been previously cured, and thus, already vulcanized. During the recycling process, any steel and tire cord (fluff) material is removed leaving essentially only granular tire rubber. The recycled tire rubber is then further granulated, pulverized or the like until the granular tire rubber can be characterized and classified by a maximum mesh size. The primary advantages realized from the use of crumb rubber are its ready availability and relatively low cost. A paving tile 20 made entirely of virgin rubber would typically cost as much as six times as much as the same paving tile made from at least about seventy-five percent (75%) crumb rubber.

The paving tile 20 is further made of a second rubber material 50 comprising a synthetic rubber copolymer of acrylonitrile (ACN) and butadiene, commercially known as nitrile rubber. Nitrile rubber is also known as Buna-N, Perbunan, acrylonitrile butadiene rubber and nitrile butadiene rubber (NBR). NBR is a family of unsaturated copolymers of 2-propenenitrile and various butadiene monomers that is particularly advantageous for the second rubber material 50 because of its unusually high resistance to caustic fuels, oils and chemicals. In general, the greater the amount of nitrile in the copolymer, the higher the resistance of the rubber material to caustic fuels, oils and chemicals. However, the trade-off chemical resistance is an accompanying loss in elasticity and flexibility. The primary advantages realized from the use of nitrile rubber, and in particular NBR, are its toughness, fuel and oil resistance, chemical resistance, stain resistance, ability to be readily cleaned, and increased surface friction due to texture and tackiness. In its raw material form, nitrile rubber is typically yellow in color and can be orange or red tinted. However, nitrile rubber may be finished in most any color by the addition of a color additive. As a result, if desired the first rubber material 40 may be a first color (e.g., black), while the second rubber material 50 is a second color (e.g., red, orange, green, etc.).

The first rubber material 40 and the dissimilar second rubber material 50 are bonded to together to form a unitary paving tile 20 having the desired combination of 1) cost; 2) toughness for durability; 3) flexibility and/or elasticity for energy absorption; 4) resistance to staining and erosion from caustic fuels, oils and chemicals and/or the environmental; and 5) surface friction or traction due to texture and/or tackiness. If desired, the first rubber material 40 and the second rubber material 50 may be bonded together by a suitable adhesive. However, in the absence of highly-controlled and closely-monitored temperature, pressure and time process requirements and/or procedures, the bond between the dissimilar materials may be insufficient for certain applications. Alternatively, the first rubber material 40 and the dissimilar second rubber material 50 may be bonded together without an adhesive, for example chemically bonded. In one embodiment, the first rubber material 40 and the second rubber material 50 are blended together and fused as a result of highly-controlled and closely-monitored temperature, pressure and time process requirements and/or procedures. It is believed that the fusing of the first rubber material 40 being previously cured crumb rubber and the second rubber material 50 being uncured, or “virgin” NBR occurs as a result of cross-linking between molecules of the SBR disposed within the crumb rubber and molecules of the NBR. In any event, the fusing of the blended crumb rubber and NBR provides a peel strength that is sufficient for most applications of the paving tiles 20.

In a particularly advantageous embodiment, a layer of the dissimilar second rubber material 50 is chemically bonded onto the first rubber material 40 without an adhesive. FIG. 12 is a flowchart depicting a method 70 for making a paving tile 20 in accordance with an exemplary embodiment of the present invention. In an initial step 72 of the method 70, a first rubber material 40 is provided. As described herein, the first rubber material 40 may comprise crumb rubber granules, for example crumb rubber granules recycled from scrap vehicle tires. If desired, a variety of different mesh sizes of crumb rubber granules may be selected and blended together to form a homogeneous dry mix of the first rubber material 40. In a next step 74 of the method 70, a second rubber material 50 is provided that is dissimilar from the first rubber material 40. As described herein, the second rubber material 50 may comprise nitrile rubber. Regardless, in a further step 76 of the method 70, the first rubber material 40 is disposed within a mold having a predetermined shape configured for forming the paving tile 20 into a desired shape, for example a dog-bone shape. The mold may be made of any material suitable for conducting heat substantially uniformly and retaining the first and second rubber materials 40, 50 of the paving tile 20 within the mold throughout the molding process, as will be described.

In a next step 78 of the method 70, the first rubber material 40 is leveled within the mold. By way of example and not limitation, crumb rubber granules disposed within the mold are leveled to a suitable extent so as to produce a desired thickness of the first rubber material 40 within the mold having a generally planar upper surface. The first rubber material 40 may be leveled in any suitable manner, for example by shaking the mold or brushing the upper surface and/or applying a sufficient amount of pressure to the upper surface. The mold may be provided with protrusions, projections, or the like depending inwardly from the bottom surface and/or the side surfaces of the mold to produce any desired negative features, such as indentations, recesses, grooves, cutouts, openings, channels or the like on the bottom surface 30 and the side surface 26, respectively, of the finished paving tile 20. Similarly, the mold may be provided with recesses, undercuts, or the like extending outwardly from the bottom surface and/or the side surfaces of the mold to produce any desired positive features, such as ribs, flanges or the like on the bottom surface 30 and the side surface 26, respectively, of the finished paving tile 20. In a next step 80 of the method 70, the first rubber material 40 disposed within the mold is compressed. The first rubber material 40 may be compressed in any suitable manner, for example by applying a sufficient amount of pressure to the upper surface to compact and compress the first rubber material to a desired degree. It should be noted that the leveling step 78 and/or the compressing step 80 may be optional depending on the composition of the first rubber material 40, and thus, the step 78 and/or the step 80 need not be performed in the making of certain paving tiles 20.

In a next step 82 following the disposing step 76 or the optional leveling step 78 and/or optional compressing step 80, a relatively thin layer of the second rubber material 50 is positioned onto the upper surface of the first rubber material 40. As previously mentioned, in one embodiment the second rubber material 50 is an uncured, or virgin, nitrile rubber, such as nitrile butadiene rubber (NBR), and the first rubber material 40 is a previously cured rubber, such as crumb rubber recycled from scrap vehicle tires. In another embodiment, the second rubber material 50 is a calendared sheet of about eighty thousands (0.080 inch) (2.0 mm) thick cured NBR. Preferably, the calendared sheet of cured NBR is pre-cut to the desired size and shape of the finished paving tile 20. In a next step 84 of the method 70, a process of at least one of a preselected temperature, a preselected pressure and a preselected time is applied to the first rubber material 40 disposed within the mold and the second rubber material 50 positioned onto the upper surface of the first rubber material.

In various embodiments of the method 70, the mold may be any type of mold suitable for applying a temperature and/or a pressure to the first and second rubber materials 40, 50. Preferably, the mold is suitable for applying at least one preselected temperature and/or at least one preselected pressure to the first and second rubber materials 40, 50 over one or more preselected periods of time. By way of example and not limitation, the mold may be operable for applying a preselected temperature and a preselected pressure to the first and second rubber materials 40, 50 for a preselected period of time. Alternatively, the mold may be operable to apply a first temperature and a first pressure to the dissimilar rubber materials for a first period of time, and subsequently, to apply a second temperature and a second pressure to the dissimilar rubber materials for a second period of time. In one embodiment, the mold is a conventional two-piece compression mold, such as a clam-shell type mold. The opposing parts, pieces or halves of the mold are brought together with the first rubber material 40 and the second rubber material 50 disposed there between. The preselected temperature(s) and the preselected pressure(s) are then applied to the first and second rubber materials 40, 50 for the preselected period(s) of time. The opposing parts, pieces or halves of the mold are then taken apart and the finished paving tile 20 is released from the mold and cooled, for example to room temperature.

In a particularly advantageous embodiment, a first rubber material 40 comprising crumb rubber granules, also referred to herein as “black rubber,” of various mesh sizes is blended and disposed within a lower half of a two-piece, clam-shell type compression mold. The crumb rubber granules may be blended with a vulcanization catalyst comprising, for example, sulphur and known accelerators. The blended black rubber is then generally leveled within the lower half of the mold. Thereafter, a second rubber material 50 comprising a relatively thin sheet of sulphur-cured nitrile rubber is positioned onto the upper surface of the leveled black rubber. If desired, the thin sheet of cured nitrile rubber material may have a different color than the black rubber material. By way of example and not limitation, the nitrile rubber sheet may have a red color, and thus, is also referred to herein as the “red rubber.” The upper half of the mold is then placed over the red rubber and joined to the lower half of the mold in a conventional manner. If desired, the mold containing the black rubber and the red rubber may be pre-heated to a temperature of between about 60° C. and about 70° C. The black rubber and the red rubber within the mold are then compressed together at a pressure of between about 1500 psi and about 2500 psi and at an elevated temperature of between about 140° C. and about 180° C. for a period of time up to about 3 minutes. In a preferred embodiment, the black rubber and the red rubber are compressed together at a pressure of between about 1800 psi and about 2100 psi, and at a temperature of at least about 140° C. for a period of time of at least about 90 seconds. If desired, the temperatures of the upper half and the lower half of the mold may be biased relative to one another. By way of example and not limitation, the temperature of the lower half of the mold may be made higher, for example about 160° C., than the temperature of the upper half of the mold, for example about 140° C.

It is believed that a lower molding temperature (i.e., between about 140° C. and about 180° C.) allows for an increased processing time of up to about 3 minutes. The increased processing window causes the red rubber to remain viscous and to flow into the black rubber, thereby permitting more complete sulphur-to-sulphur cross-linking to occur. Consequently, the lower surface of the red rubber material effectively “blends” into the upper surface of the black rubber material and creates an exceptionally strong bond that has not been attainable using previously known methods. The lower temperature and longer time period molding process of the method of the invention permits vulcanization, or secondary polymerization, of the previously sulphur-cured red rubber with the blended black rubber and sulphur-based catalyst. In addition, the lower temperature and longer time period compression molding process may promote further cross-linking.

It has been determined as a result of extensive testing that the first rubber material 40 being crumb rubber or “black rubber” and the second rubber material 50 being nitrile rubber, NBR or “red rubber” have distinctly different material properties. It has also been proven that a paving tile 20 made of a first rubber material 40 being crumb rubber (black rubber) and a dissimilar second rubber material 50 being nitrile rubber (red rubber) that are chemically bonded together without an adhesive according to the compression molding process described herein has a peel strength sufficient for all anticipated applications. In particular, it has been determined that a paving tile made of recycled crumb rubber granules (black rubber) bonded with a relatively thin calendared sheet of sulphur-cured NBR (red rubber) may be formed with a peel strength (peel force per unit width of bond line) of at least about 13.2 (ft-lbs)/in.

The testing showed that pavers made only of black rubber material had less than one hundred percent (100%) strain to break and less than five hundred pounds per square inch (500 psi) stress at break. The hardness of the black rubber paver material was about 71-72 durometer with a density of about 1.16 g/cc. The paver material had a DIN abrasion value of 209 mm³ and the compression set was less than twenty percent (20%). The compressive strength to break was over one hundred thousand pounds per square inch (100,000 psi) load to break. By comparison, the red rubber material used to form pavers according the process previously described, had over nine hundred percent (900%) strain to break and over two thousand pounds per square inch (2000 psi) stress at break. The DIN abrasion value of the red rubber material was 233 mm³, slightly higher than the black rubber material DIN abrasion value of 209 mm³. Conversely, the compression set of the red rubber material was less than twenty-five percent (25%) at 23.7% compared to the less than twenty percent (20%) compression set of the black rubber material.

The foregoing has described one or more exemplary embodiments of paving tiles made of rubber materials and associated methods for making and using paving tiles according to the present invention. In particular embodiments, the paving tiles are made of recycled crumb rubber material and a dissimilar sulphur-cured nitrile rubber material that are chemically bonded together without an adhesive. Exemplary embodiments of paving tiles and methods for making and using the paving tiles according to the invention have been shown and described herein for purposes of illustrating and enabling the best mode of making, using practicing the invention. Those of ordinary skill in the art, however, will readily understand and appreciate that numerous variations and modifications of the invention may be made without departing from the spirit and scope thereof. Accordingly, all such variations and modifications are intended to be encompassed by the appended claims.

1. A paving tile, comprising:
a first rubber material; and
a second rubber material that is dissimilar from the first rubber material.

2. The paving tile according to claim 1, wherein one of the first rubber material and the second rubber material is a recycled rubber material.

3. The paving tile according to claim 2, wherein the recycled rubber material comprises at least one of a styrene-butadiene rubber (SBR), a butyl rubber (BR) and a natural rubber (NR) that has been previously cured.

4. The paving tile according to claim 1, wherein the first rubber material is a recycled rubber material and the second rubber material is a nitrile rubber material.

5. The paving tile according to claim 4, wherein the nitrile rubber material is selected from the group consisting of Buna-N, Perbunan, acrylonitrile butadiene rubber and nitrile butadiene rubber (NBR).

6. The paving tile according to claim 4, wherein the recycled rubber material comprises crumb rubber granules recycled from scrap vehicle tires.

7. The paving tile according to claim 4, wherein the first rubber material is a recycled crumb rubber material and the second rubber material is a nitrile butadiene rubber (NBR) material, and wherein the crumb rubber material and the NBR material are bonded together to form a unitary paving tile.

8. The paving tile according to claim 4, wherein the recycled rubber material and the nitrile rubber material are blended and fused together.

9. The paving tile according to claim 4, wherein the recycled rubber material and the nitrile rubber material are bonded together with an adhesive.

10. The paving tile according to claim 4, wherein the recycled rubber material and the nitrile rubber material are bonded together without an adhesive.

11. The paving tile according to claim 10, wherein the recycled rubber material comprises a crumb rubber material and the nitrile rubber material comprises a nitrile butadiene rubber (NBR) material, and wherein a relatively thin layer of the NBR material is bonded onto the crumb rubber material without an adhesive to form a unitary paving tile.

12. The paving tile according to claim 11, wherein the NBR material is bonded onto the crumb rubber material within a mold using a preselected process comprising at least one of a preselected temperature, a preselected pressure and a preselected time.

13. The paving tile according to claim 11, wherein the peel strength of the bond between the crumb rubber material and the NBR material is at least as great as 13 foot-pounds per inch (13 (ft-lbs)/in).

14. The paving tile according to claim 1, wherein the first dissimilar material has a first color and the second dissimilar material has a second color that is different than the first color.

15. A method of making a paving tile from rubber materials, comprising:
providing a first rubber material;
providing a second rubber material that is dissimilar from the first rubber material;
bonding the first rubber material and the second rubber material together.

16. The method according to claim 15, wherein bonding the first rubber material and the second rubber material together comprises bonding without an adhesive.

17. The method according to claim 15, further comprising:
disposing the first rubber material within a mold; and
positioning a relatively thin layer of the second rubber material onto an upper surface of the first rubber material; and
applying at least one of a preselected temperature, a preselected pressure and a preselected time to the first rubber material and the second rubber material disposed within the mold.

18. The method according to claim 17, further comprising:
leveling the first rubber material after disposing the first rubber material within the mold and before positioning the layer of the second rubber material onto the first rubber material.

19. The method according to claim 15, wherein the first rubber material is a recycled rubber material and wherein the second rubber material is a nitrile rubber material.

20. The method according to claim 19, wherein the recycled rubber material comprises crumb rubber granules that have been previously cured and the nitrile rubber material comprises NBR.

21. A paving tile made of a first material comprising a recycled rubber material and a second material comprising a nitrile rubber material, the paving tile being made by disposing the recycled rubber material within a mold, leveling the recycled rubber material, positioning a relatively thin layer of the nitrile rubber material onto the recycled rubber material, and applying at least one of a preselected temperature and a preselected pressure for a preselected time to bond the recycled rubber material and the nitrile rubber material together to form a unitary paving tile.

22. The paving tile according to claim 21, wherein the recycled rubber material has a first color and the nitrile rubber material has a second color that is different than the first color.
